(19) United States
(12) Patent Application Publication
(10) Pub. No.: US 2025/0042024 A1
(43) Pub. Date: Feb. 6, 2025

(54) AFFORDANCE-BASED CONTROL SYSTEM

(71) Applicant: QUALCOMM Incorporated, San Diego, CA (US)

(72) Inventors: Daniel Hendricus Franciscus DIJKMAN, Haarlem (NL); Pietro MAZZAGLIA, Ghent (BE); Taco Sebastiaan COHEN, Amsterdam (NL)

(21) Appl. No.: 18/599,741

(22) Filed: Mar. 8, 2024

Related U.S. Application Data
(60) Provisional application No. 63/504,293, filed on May 25, 2023.

(51) Int. Cl. B25J 9/16

(52) U.S. Cl. CPC B25J 9/163; B25J 9/161; B25J 9/1633; B25J 9/1669

(57) ABSTRACT

Certain aspects of the present disclosure provide techniques and apparatus for processing data via a set of machine learning models to cause a device to perform a task. The method generally includes accessing data characterizing a physical environment in which a device is operating. A set of affordable actions is generated based on processing the data via a first set of machine learning models. A selected action to be performed in the physical environment is generated via a second set of machine learning models based on the set of affordable actions and a task. The device is then caused to execute the first selected action.

### CROSS-REFERENCE TO RELATED APPLICATIONS

This application claims priority to and benefit of U.S. Provisional Patent Application Ser. No. 63/504,293, entitled “Affordance-Based Control System,” filed May 25, 2023, and assigned to the assignee hereof, the entire contents of which are incorporated by reference herein.

### INTRODUCTION

Aspects of the present disclosure relate to neural networks.

Robotic systems are used to perform a wide variety of tasks today. Additionally, the use of robots has increased substantially, and is expected to continue to increase. For example, robotic arms can be used to manipulate and move objects or to perform other actions, such as on a vehicle assembly line. As the desired tasks have expanded, the robotic control systems have similarly grown increasingly complex. Beyond controlling the positioning of robotic manipulators with high accuracy (which may include not only positioning and/or orientation of any end effectors such as graspers, but also of the other components of the arm itself), control systems may also obtain and use information about their environment. For example, before a robotic arm can be used to pick up objects in some cases, the control system may first determine environmental context, such as where the objects are, how the objects are positioned/oriented, how the objects can be lifted, and/or the like.

### BRIEF SUMMARY

Certain aspects provide a processor-implemented method. The method generally includes accessing data characterizing a physical environment in which a device is operating. A set of affordable actions is generated based on processing the data via a first set of machine learning models. A selected action to be performed in the physical environment is generated via a second set of machine learning models based on the set of affordable actions and a task. The device is then caused to execute the first selected action.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates a block diagram of an affordance-based control system, according to aspects of the present disclosure.

FIG. 2 illustrates an example architecture for generating affordance maps, according to aspects of the present disclosure.

FIG. 3 illustrates an example architecture for generating affordance maps and uncertainty maps, according to aspects of the present disclosure.

FIG. 4 illustrates an example pipeline for performing a task within a physical environment based on a set of affordable actions, according to aspects of the present disclosure.

FIG. 5 illustrates example operations for performing a task within a physical environment based on a set of affordable actions, according to aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for generating actions to be executed by a device to cause the device to perform a task within a physical environment.

Complex manipulation tasks performed, for example, by a robot or other autonomous system typically include several steps. Each of these steps is generally based on knowledge of the physical environment in which a robot is located and possible interactions that may occur with objects in the physical environment. For example, the task of preparing a kettle of hot water involves several sub-tasks, including grasping the kettle, moving the kettle into the sink, turning the faucet on to let water flow into the kettle, turning the faucet off when the kettle is sufficiently filled, placing the kettle onto a burner, and turning the knob of the correct burner, with each task being preconditioned on the successful execution of a prior task. Various types of neural networks can be implemented to process data characterizing a physical environment in order to enable a device, such as a robot, to perform these types of tasks within the physical environment. For example, neural networks may process image data (e.g., still images or streams of visual content) to detect objects, predict future motion of objects detected in visual content, segment visual content into different semantic groups, etc.

However, such techniques generally consider the entire physical environment and/or an unrestricted set of options when determining a next action to be performed by the device to accomplish a particular task. For example, a device may encounter a large number of objects within an environment, and performing the task successfully may be preconditioned on accurate identification and classification of the objects in the environment. Additionally, because the controlling neural networks typically do not have knowledge indicating which skill(s) can be performed where and/or with respect to which object(s) (e.g., a cup is picked up at the handle, a door is opened by turning the knob, etc.), the controlling neural networks generally further determine how and/or whether the device can interact with each object, adding further complexity to the decision-making process. As a result, such techniques are computationally expensive and generally have limited success in enabling a device to interact with objects to perform a task within the physical environment, as the number of possibilities to evaluate may become intractably large as the number of objects in an environment and possible actions to perform with respect to these objects scale.

Aspects of the present disclosure provide techniques for effectively determining a next action to be performed by a device to accomplish a task. As discussed below in further detail, the techniques described herein process data characterizing a physical environment (e.g., image data) via a first set of machine learning models (also referred to herein as affordance models) to identify a set of affordable actions that can be performed within a physical environment. Each affordable action may indicate an action that can be performed at a particular location in the physical environment using a set of action parameters (e.g., a grasp location, a grasp orientation, where to push/pull an object, a direction in which to push/pull an object, how quickly to pour water, how much water to pour, etc.). The set of affordable actions is then processed by a second set of machine learning models (also referred to herein as control models) in conjunction with a task-which may be decomposed by the control models into a sequence of sub-tasks-to generate a next action to be performed by a device (e.g., a robot) to accomplish the task. Once the next action has been performed by the device, additional data characterizing a physical environment is processed by the affordance models to identify one or more additional affordable actions, which are then processed by the control models to generate another next action to be performed by the device to accomplish the task (e.g., by performing the next sub-task included in the sequence of sub-tasks).

By pre-training the affordance models to first identify affordable actions in the physical environment and then enabling the control models to select between the affordable actions, the techniques described herein enable a device to perform actions associated with a task with a higher success rate and with lower computational costs, relative to techniques in which a neural network considers the entire physical environment and/or an unrestricted set of options when determining a next action. Additionally, providing a set of affordable actions to the control models that are controlling the device further enables faster learning of more complex tasks, such as tasks that include a sequence of several sub-tasks that are to be performed within the environment and/or which may entail the development of plans grounded in the set of affordable actions based on the current state of the environment.

### Example Affordance-Based Control Systems

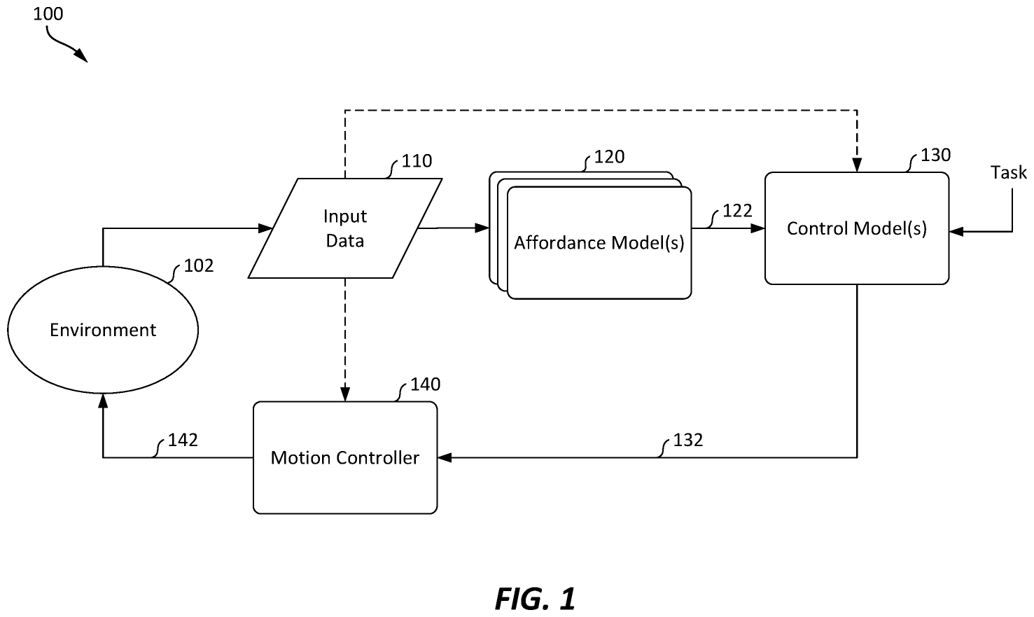

FIG. 1 illustrates a block diagram of an affordance-based control system 100, according to aspects of the present disclosure. The affordance-based control system 100 includes one or more devices (e.g., image sensors, light sensors, depth sensors, actuators, force sensors, torque sensors, chemical sensors, temperature sensors, etc.) that acquire input data 110 associated with the environment 102. The affordance-based control system 100 further includes a set of affordance models 120, a set of control models 130, and a motion controller 140. The motion controller 140 may be in communication with a device (not shown), such as a robotic arm, an autonomous or semi-autonomous vehicle, a humanoid robot, etc.

As shown in FIG. 1, the input data 110 is accessed by the affordance models 120. As used herein, accessing data can generally include receiving, retrieving, requesting, or otherwise gaining access to the data. The input data 110 may include, for example, any type of information indicating the current state of the device and/or any information indicating the location(s) of one or more objects included in the physical environment 102. For example, the input data 110 may include image data corresponding to preprocessed image data (e.g., processed via an image signal processor to generate red, green, and blue (RGB) pixel values, depth values, etc.) and/or raw image sensor data (e.g., photon counts). In addition, the input data 110 may include state associated with the device, such as, for example, a location, orientation, velocity, and/or acceleration of an end effector; an angle, velocity, and/or acceleration of a joint; etc. The input data may include spatial data generated by various sensors, such as distance data (from a defined datum point) generated based on ultrasonic measurement sensors, light detection and ranging (LIDAR) systems, or the like.

In operation, the affordance models 120 process the input data 110 (e.g., including a current state of the device and image data) to identify one or more features corresponding to a set of affordable actions 122 that can be performed in the environment 102. For example, with respect to a grasping skill, an affordance model 120 may process the input data 110 to identify a graspable portion of an object which can be grasped by the device in order to manipulate the object (e.g., to identify a handle of a mug which can be grasped by the device to move the mug within a three-dimensional space). Additionally, the same or a different affordance model 120 may process the input data 110 to identify a different graspable portion of the object (e.g. a body of the mug), which can also be grasped by the device to manipulate the object. The set of affordable actions 122 is then passed to the control models 130.

The control models 130 receive a task and decompose the task into a sequence of sub-tasks that can be performed by the device to accomplish the task. Generally, the sequence of sub-tasks may be temporally related such that the completion of one sub-task is a precondition for performing a subsequent sub-task. The control models 130 process the set of affordable actions 122 in conjunction with the task (e.g., in conjunction with the sequence of sub-tasks, such as a previous sub-task, a current sub-task, and/or a next sub-task included in the sequence of sub-tasks) in order to select a particular affordable action from the set of affordable actions 122, as described in further detail in conjunction with FIG. 1. The control models 130 then generate a next action 132 to be performed by the device based on the selected affordable action. The next action 132 is passed to the motion controller 140, which converts action parameters associated with the next action 132 into control signals 142 for output to the device. Updated input data 110 is then accessed by the affordance models 120, which generate an updated set of affordable actions 122 based on the current state of the device and the current state of objects included in the physical environment. In this manner, a sequence of next actions 132 for performing a task can be generated by the control models 130 based on a finite and tractable set of affordable actions 122 received from the set of affordance models 120, enabling a task being executed by the control models 130 to be incrementally performed by a device with a high probability of success and low computational burden.

In various aspects, each affordable action may indicate a set of action parameters that can be implemented by the device to perform the action. The action parameters may include, for example, a location (e.g., x, y, z coordinates or polar coordinates) at which an action can be performed in the physical environment 102, an orientation (e.g., specified as a quaternion, a rotation matrix, etc.) to be implemented when interacting with an object, and/or a force (e.g., specified as a scalar, force vector, torque vector, etc.) to be applied when interacting with an object. For example, an affordable action generated by an affordance model 120 may include parameters indicating that a grasping action can be performed at (x, y, z) coordinates corresponding to the location of a handle of a mug, an orientation (e.g., of a robotic grasper) at which the handle is to be grasped by the device, and/or a force (e.g., applied by a robotic grasper to the handle) with which the handle is to be grasped by the device.

As shown in FIG. 1, the input data 110 may also be accessed by the motion controller 140 and/or control models 130. For example, the motion controller 140 may access the input data 110, including the state of the device, in order to enable a feedback mechanism to control movement of the device (e.g., movement of a grasper or other end effector of a robot) towards a target location, to control movement and/or features of the device towards a target orientation of the device, to apply a target force via the device, etc. Additionally, the control models 130 may access the input data 110, including the state of the device and/or image (or other sensor) data from the physical environment 102, in order to supervise execution of a next action 132 by the device. For example, the control models 130 may access the input data 110 to identify when the device is within a threshold distance of a target location, to predict that the device is likely to collide with an object in the physical environment 102, to determine when an action (e.g., pouring water from a kettle) corresponding to a task should be stopped (e.g., based on action parameters indicating an amount of water to pour), etc. In such cases, the control models 130 may send a stop signal to cause the device to cease performing an action. Additionally or alternatively, the control models 130 may monitor the state of the device, determine that the action being performed by the device should be modified in some manner, and then adjust the action parameters accordingly. For example, the control models 130 may access the input data 110 to identify when the device should make minor adjustments to the device's location and/or orientation, for example, to cause the device to change the angle of a kettle to pour water more quickly or slowly, to cause the device to slightly adjust the location of a bottle in order to pour a carbonated beverage along the side of a glass instead of down the center of the glass, to cause the device to slightly adjust the location of a knife to cut slices of bread more uniformly, to avoid a collision with an object in the environment, etc. The control models 130 may then adjust the action parameters—while the device is executing the next action—and output the adjusted action parameters to the motion controller 140 to make the minor adjustments to the location and/or orientation of the device.

In various aspects, the affordance models 120 may include a set of machine learning models, where each machine learning model has been trained to identify affordable actions associated with a different type of skill (e.g., grasping, pushing, pulling, opening, turning, etc.) that can be performed by a device on an object located in the environment 102. In some aspects, the affordance models 120 include a set of convolutional neural networks (CNNs), such as a set of fully convolutional neural networks (FCNNs). However, in various aspects, any type of machine learning model capable of being trained to identify features in image or other sensor data may be implemented, such as, for example, a transformer neural network model, a recurrent neural network (RNN), an autoencoder, a diffusion model, etc.

The affordance models 120 may be pre-trained on one or more large-scale datasets and/or the affordable actions (e.g., and associated action parameters, probabilities of success, etc.) may be learned online in an end-to-end interactive fashion (e.g., via reinforcement learning). In some aspects, the affordance models 120 may generate one or more affordance maps. Each affordance map may include image data representing one or more locations within the physical environment 102 at which an affordable action is to be performed. For example, an affordance map may include pixel encodings (e.g., colorized pixels) indicating a region of an object to be grasped by the device. Additionally, action parameters, such as an orientation to be implemented, a force to be applied, a probability of successfully interacting with the object, etc. may be embedded in, appended to, or otherwise included with each affordance map. For example, an affordance map may indicate, for each location (e.g., each pixel in an image), the probability that one or more actions can be performed at the location (e.g., a grasping action). In some aspects, the affordance maps indicate the probability that a given action will be successfully completed for each location in a scene, if the corresponding set of action parameters are used.

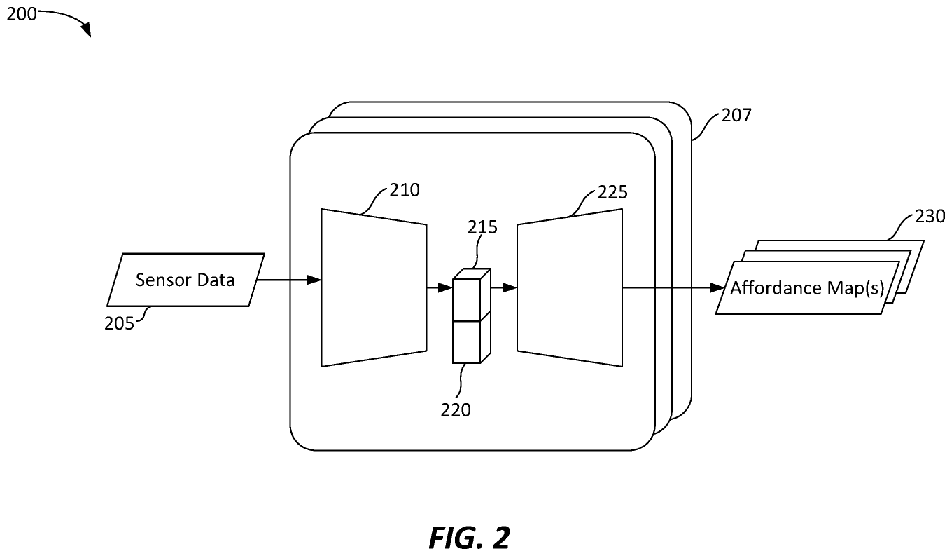

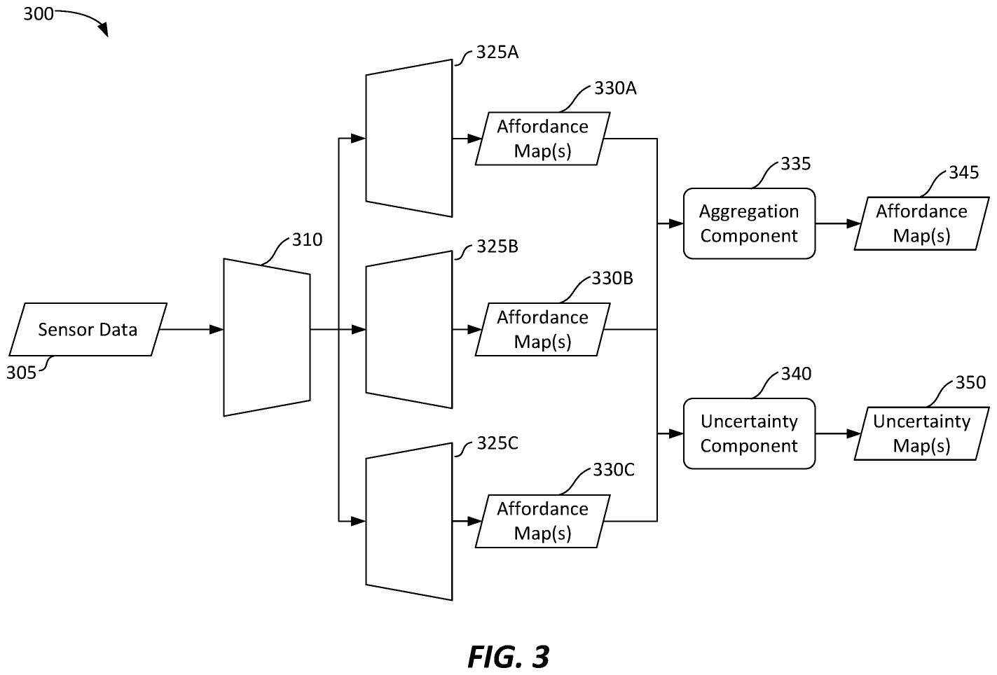

The affordance models 120 may further process the affordance map(s) to generate textual description(s) representing the set of affordable actions 122, which may then be passed to the control models 130. Alternatively, the affordance models 120 may output the one or more affordance maps to the control models 130 as representing the set of affordable actions 122 that can be performed by the device to accomplish the task. Example architectures for generating affordance maps and uncertainty maps are described below in further detail in conjunction with FIG. 2 and FIG. 3.

In various aspects, the control models 130 may include a set of machine learning models, such as generative artificial intelligence models (e.g., a transformer neural network model, a RNN, a CNN, an autoencoder, a diffusion model, etc.). Generally, generative artificial intelligence models generate a response to a query inputted into the model. For example, a large language model (LLM) can generate a response to a query that includes a set of affordable actions 122 and a task (e.g., including a sequence of sub-tasks) using multiple passes through the large language model, with each successive pass being based on the query and the tokens (e.g., corresponding to next actions 132) generated using previous passes through the large language model.

For example, the control model 130 may include a plurality of generative artificial intelligence models. A first generative artificial intelligence model may generate a plan identifying a plurality of actions to be performed in order to complete a task specified as an input into the control models 130. Based on the plurality of actions in the plan generated by the first generative artificial intelligence model and the outputs of the affordance models 120, a second generative artificial intelligence model may generate executable code instructing the motion controller 140 to execute each of the plurality of actions.

The control models 130 may support flexible inputs that enable different parameterizations to be implemented for different types of affordable actions. For example, the control models 130 may receive textual description(s) corresponding to the set of affordable actions 122 and including one or more words. The textual description(s) may then be processed by the control models 130 (e.g., by tokenizing the textual description(s), generating input embeddings based on the tokens and the task and/or sub-task(s)) to generate a next action 132. In some aspects, the control models 130 may include an LLM that generates a sequence of (next-word) tokens corresponding to the sequence of next actions 132 to be executed by the device to perform a sequence of sub-tasks for accomplishing the task. Additionally or alternatively, the control models 130 may receive image data, such as one or more affordance maps, which may be decomposed into a set of patches that are then processed by the control models 130 to generate a sequence of next actions 132 to be executed by the device to perform a sequence of sub-tasks for accomplishing the task.

In various aspects, the control models 130 generate a next action 132 to be performed by selecting an affordable action from the set of affordable actions 122 and passing the set of action parameters associated with the selected affordable action to the motion controller 140. Each affordable action included in a set of affordable actions 122 may indicate a respective probability that the affordable action can be performed at the specified location in the physical environment, and the control models 130 may select an affordable action having a highest probability of the set of affordable actions. In some aspects, the control models 130 may generate a next action 132 to be performed by first selecting an affordable action from the set of affordable actions 122 and then modifying the set of action parameters associated with the selected affordable action. For example, in some aspects, the control models 130 may implement reinforcement learning techniques to iteratively interact with and receive feedback from the environment to learn minor or major adjustments that should be made to action parameters to adjust the manner in which the device performs a particular next action 132. The next action 132, including the set of modified action parameters, is then passed to the motion controller 140. For example, in some aspects, sets of action parameters associated with affordable actions outputted by the affordance models 120 may be discretized into a finite number (e.g., 10, 100, 500, 1000, etc.) of values, such as by implementing a set of orientation values for each degree of freedom associated with the movement (e.g., rotation) of an end effector of the device. In other examples, the control models 130 may take into account (e.g., based on the input data 110 received by the control models 130) that an object has a particular velocity and, thus, is no longer at a location and/or orientation indicated by the set of affordable actions 122 outputted by the affordance models 120. Accordingly, in these examples, the control models 130 may fine tune (or make significant changes to) a given set of action parameters in order to generate a next action 132 that enables the device to more effectively interact with the physical environment 102.

After the device executes a next action 132, the affordance models 120 may generate a different set of affordable actions 122 to reflect the affordances that are now available to the device. For example, after the device grasps (or releases) an object within the environment, a different set of affordable actions 122 may be generated by the affordance models 120 to reflect different actions that can be performed with the object now being grasped by the device. Accordingly, each affordable action included in a set of affordable actions 122 generated by the affordance models 120 may include an action that can be performed conditioned on the device having executed at least one prior action.

For example, if the device is handling a kettle, then the set of affordable actions 122 generated by the affordance models 120 may include, for example, turning on a water faucet (e.g., to enable the device to fill the kettle with water) and turning on a stove burner (e.g., to enable the device to heat water in the kettle). Once the kettle is released, then the set of affordable actions 122 generated by the affordance models 120 may include, for example, turning one or more stove burner knobs, grasping a handle of the kettle, grasping a handle of a tea cup, and grasping and/or pulling a cabinet door handle. In another example, if the device grasps a kitchen knife, then the set of affordable actions 122 generated by the affordance models 120 may include, for example, cutting a loaf of bread sitting on a countertop, inserting the knife into a knife block, opening a utensil drawer, placing the knife in a kitchen sink, and placing the knife in a dishwasher.

### Example Architecture for Generating Affordance Maps

FIG. 2 depicts an example architecture 200 for generating affordance maps. In some aspects, the architecture is used by a control system, such as the affordance-based control system 100, to train the model(s) and/or to generate affordance maps and afforable actions that drive action selection, as discussed in more detail below.

In the illustrated example, sensor data 205 (which may correspond to the input data 110 of FIG. 1) is evaluated by a machine learning model 207 (referred to in some aspects as affordance models, which may correspond to the afformance models 120) to generate affordance maps 230. In some aspects, the machine learning model 207 is an ensemble (e.g., a combination of multiple models) of deep learning models (e.g., convolution-based models). In some aspects, the sensor data 205 is collected and/or received from a camera (e.g., the sensor data may indicate the color and depth of each pixel in an image).

In the illustrated example, the machine learning model 207 includes one or more encoders 210 and one or more decoders 225. In some aspects, if the machine learning model 207 is an ensemble, then each encoder and decoder pair may correspond to a single model within the ensemble. That is, there may be multiple models, each including a corresponding encoder 210 and decoder 225, in the machine learning model 207. In some aspects, a single shared encoder 210 may be used in combination with a set of multiple decoders 225 in the ensemble.

As illustrated, each encoder 210 generates a latent tensor 215 based on the input sensor data 205. For example, as discussed above, the encoder 210 may process the sensor data 205 using one or more convolution layers to extract salient features and generate the latent tensor 215. In the illustrated example, in this latent space, an action parameter tensor 220 can be combined with the latent tensor 215. For example, the action parameter tensor 220 may be appended to or concatenated with the latent tensor 215, added to the latent tensor (e.g., via element-wise addition), and the like.

In some aspects, the action parameter tensor 220 may generally encode one or more action parameters for performing the action, as discussed above. For example, the action parameter tensor 220 may encode the grasping orientation to be used. In some aspects, the control system generates multiple combined or aggregated latent tensors using a multiple action parameter tensor 220. For example, for each respective combination of action parameter values, the control system may generate a corresponding aggregated latent tensor (including both the latent tensor 215 and a respective action parameter tensor 220).

As one example, for categorical action parameters (e.g., whether to push or pull an object, whether to rotate the object left or right, and the like), the action parameter tensor 220 may encode a specific combination or set of categories (e.g., a first set of action parameters indicating to rotate the object to the right while pushing the object, a second set indicating to rotate the object to the right while pulling the object, a third set indicating to rotate the object to the left while pushing the object, and a fourth set indicating to rotate the object to the left while pulling the object).

As another example, in some aspects, continuous action parameters (e.g., grasp orientation, action force, and the like) may be discretized into a set of categories or values, and the action parameter tensor 220 may encode a specific combination for such categories or values. For example, the orientation and force options may be discretized into some number (e.g., five hundred) of possible orientations and/or forces.

In this way, the control system may use a single latent tensor 215 to generate a larger number of aggregated latent tensors by combining a copy or instance of the single latent tensor 215 with each unique action parameter tensor 220 in turn (in sequence or in parallel).

In the illustrated example, the control system then passes each aggregated latent tensor through a decoder 225 to generate one or more affordance maps 230. As used herein, an “affordance map” is generally a data structure representing the probabilities that one or more locations in an environment correspond to possible action(s). For example, as described above, an affordance map may indicate, for each location (e.g., each pixel in an image), the probability that one or more actions can be performed at the location (e.g., a grasping action). In some aspects, each decoder 225 generates an affordance map 230 for each aggregated latent tensor. For example, if grasp orientation is the only action parameter and there are three hundred discrete orientations that the control system considers, then three hundred aggregated latent tensors may be generated, and the decoder 225 may be used to generate three hundred affordance maps 230 (in sequence or in parallel). Additionally, as discussed above, if the machine learning model 207 is an ensemble (e.g., with multiple decoders, each either using a corresponding encoder or using a shared encoder), then each decoder 225 may generate the same number of affordance maps 230. Continuing the above example, if there are five branches or decoders 225 in the machine learning model 207, then each decoder 225 may generate a corresponding set of three hundred affordance maps 230 for a total of fifteen-hundred affordance maps 230 generated based on a single set of input sensor data 205.

As each affordance map 230 is generated based on a corresponding set of action parameters (encoded in the action parameter tensor 220), each affordance map thereby corresponds to or indicates a predicted set of success probabilities if the corresponding set of action parameters are used to perform the action (e.g., an affordable action). In some aspects, the affordance maps 230 indicate the probability that the given action will be successfully completed for each location in the scene (as depicted in the sensor data 205), if the corresponding set of action parameters are used (e.g., the probability that a grasp action will be successful if the end effector is used to grasp at each location). For example, if the sensor data 205 comprises image data, then each affordance map 230 may include a predicted success probability for each pixel (or other logical portion) of the image, indicating the probability that the action will be successful if the action is performed at the physical location that corresponds to or is depicted by the pixel.

In some aspects, the affordance maps 230 can be collectively thought of as maps of Bernoulli distributions, one per each point or pixel in the input data. That is, each decoder 225 in the ensemble may generate a corresponding affordance map 230 for each set of action parameters. Accordingly, for each location (e.g., each pixel), there may be multiple predicted success probabilities for each set of action parameters (e.g., one generated by each decoder 225).

In some aspects, during training, the control system explores uncertainty in grasping points and orientations (or other parameters), as discussed in more detail below. This can allow the control system to rapidly learn (e.g., to update the parameters of the decoder(s) 225 and encoder(s) 210. In some aspects, during runtime (when robustness is typically desired), the control system may evaluate the affordance maps 230 to identify the specific action (e.g., a specific location and grasp orientation) that results in the highest probability of success.

### Example Architecture for Generating Affordance Maps and Uncertainty Maps

FIG. 3 depicts an example architecture 300 for generating affordance maps and uncertainty maps. In some aspects, the architecture 300 is used by a control system, such as the affordance-based control system 100, to train the model(s) and/or to generate affordance maps and affordable actions that drive action selection, as discussed in more detail below. In some aspects, the architecture 300 provides additional detail for the architecture 200 of FIG. 2. In the illustrated example, sensor data 305 (which may correspond to the input data 110 of FIG. 1 and/or the sensor data 205 of FIG. 2) is evaluated to generate affordance maps 345 (which may correspond to affordance maps 230 of FIG. 2) and uncertainty maps 350.

In the illustrated example, the sensor data 305 is processed by an encoder 310 (which may correspond to the encoder 210 of FIG. 2) to generate a latent tensor, which is combined with one or more action parameter tensors and is processed by a set of decoders 325A-C(collectively, decoders 325), which may correspond to the decoder 225 of FIG. 2. For example, as discussed above, each decoder 325 may correspond to a branch or model of the ensemble. In the illustrated example, a shared encoder 310 is used for each decoder 325. In some aspects, as discussed above, each decoder 325 may have its own corresponding encoder 310. Additionally, though three decoders 325 are depicted, in other aspects, there may be any number of decoders 325 or branches in the model ensemble.

As illustrated, each decoder 325 generates an interim affordance map 330 for each set of action parameters based on the sensor data 305. Specifically, the decoder 325A generates the interim affordance maps 330A, the decoder 325B generates the interim affordance maps 330B, and the decoder 325C generates the interim affordance maps 330C. In some aspects, as discussed above, the interim affordance maps 330 may generally indicate probabilities that an action will be successful if the action is performed at one or more specific locations using one or more specific action parameters (e.g., at a specific point on an object and using a specific grip orientation).

In the illustrated example, the generated interim affordance maps 330 are provided to an aggregation component 335 and an uncertainty component 340. Generally, the aggregation component 335 aggregates the interim affordance maps 330 to generate the output affordance map(s) 345. For example, the aggregation component 335 may perform element-wise summation or averaging. In some aspects, each affordance map 345 may therefore include action success probabilities determined based on the collective predictions contained within each interim affordance map 330 (e.g., the average probability of success for each pixel). In some aspects, as discussed above, there may be an affordance map 345 for each unique set of possible action parameters for performing the action.

That is, for each respective set of action parameter values (e.g., each action parameter tensor), the aggregation component 335 may identify the corresponding set of interim affordance maps 330 (one generated by each decoder 325) for the set of parameter values and aggregate this set to generate an output affordance map 345 for the set of action parameter values. In this way, the total number of affordance maps 345 may match the number of unique action parameter values. For example, if there are three hundred unique options, then the aggregation component 335 may generate three hundred output affordance maps 345, one for each option.

In the illustrated example, the uncertainty component 340 generates a set of uncertainty maps 350 based on the interim affordance maps 330. In some aspects, the uncertainty maps 350 indicate the uncertainty of the model with respect to the affordance maps. For example, if the predicted probability of success for a single point varies substantially between interim affordance maps 330A, 330B, and 330C, then the uncertainty component 340 may determine that uncertainty is high for the single point. In some aspects, the uncertainty maps 350 are generated using a Jensen-Shannon Divergence (JSD) approach (also referred to in some aspects as the information radius).

In some aspects, a respective uncertainty map 350 is generated for each set of action parameters. That is, for each respective set of action parameter values (e.g., each action parameter tensor), the uncertainty component 340 may identify the corresponding set of interim affordance maps 330 (one generated by each decoder 325) for the set of parameter values, and evaluate this set to generate the uncertainty map 350 for the set of action parameter values, indicating the success uncertainty at each location if the set of parameter values is used. In this way, the total number of uncertainty maps 350 may match the number of unique action parameter values. For example, if there are three hundred unique options, then the uncertainty component 340 may generate three hundred output uncertainty maps 350, one for each option.

In some aspects, the uncertainty value for each point (e.g., each pixel) may be defined using Equation 1 below:

$$u ( s , a ) = JSD ( p ( g \vert s , a , θ ) \vert θ ∼ Θ ) ) == H ( {𝔼}_{θ ∼ Θ} [ p ( g \vert s , a , θ ) ] ) - {𝔼}_{θ ∼ Θ} [ H ( p ( g \vert s , a , θ ) ) ] \qquad ( 1 )$$

where u(s, a) is the uncertainty value for a given state s (e.g., the state of the robot and/or environment, such as for a given location or pixel in the input) and set of action parameters a, JSD(⋅) is the JSD function, p(g|s, a) is the probability of successfully performing the action g with the action parameters a in state s (e.g., at location s in the environment), and θ is a set of parameters sampled from the set of ensemble parameters Θ (where θ corresponds to the parameters of a specific model or branch of the ensemble, such as a single decoder 325). That is, the uncertainty may be defined as the entropy (H) of the expected ( [symbol] ) probability of success (e.g., the mean probability across the interim affordance maps 330 for the set of action parameters), minus the expected entropy of the predicted probabilities of success. In this way, the uncertainty component 340 can generate a respective uncertainty map 350 for each respective set of action parameters, indicating the model uncertainty with respect to each location in the space (e.g., for each pixel in image data) and with respect to each set of action parameters.

In some aspects, these uncertainty maps 350 may be used during training and/or during inferencing. For example, during training, the control system may use the affordance maps 345 and uncertainty maps 350 to select an action that maximizes (or at least increases) predicted success while also minimizing (or at least reducing) uncertainty in order to learn more rapidly. During inferencing (when maximum robustness is desired), the control system may select an action that maximizes, or at least increases, predicted success. In some aspects, in addition to maximizing, or at least increasing, predicted success, the control system may also seek to minimize, or at least reduce, the uncertainty.

In some aspects, during the training or exploration phase, the control system can perform ensemble sampling. For example, for each set of input sensor data 305 (e.g., each time an action is requested or desired), the one member of the ensemble (e.g., one decoder 325) may be selected with at least an element of randomness (e.g., selecting the decoder randomly or pseudo-randomly). In some aspects, the interim affordance maps 330 generated by this selected decoder are the most important or dominant maps during this exploration stage for the current input data. For example, rather than using the output affordance maps 345, the control system may use the interim affordance maps 330 generated by the (randomly selected) decoder 325 during exploration. This can make the training process faster by adding noise to the training data to accelerate generalization.

In some aspects, the uncertainty values (reflected in the uncertainty maps 350) may be summed with the probability values of the corresponding interim affordance maps 330 of the selected decoder 325. That is, for each set of action parameter values, the control system may sum the corresponding uncertainty map 350 with the corresponding interim affordance map 330. For example, the control system may perform element-wise summation to add the uncertainty value for each location (e.g., each pixel) with the predicted probability of action success for each location. In some aspects, this summation is performed for each interim affordance map 330 generated by the selected decoder 325 (e.g., for each set of action parameters).

As the uncertainty maps 350 reflect the information radius with respect to performing the action using each configuration of action parameters, the control system can use the uncertainty maps to provide a proxy of the information that can be gained by attempting the action at each location using the indicated set of parameters. By summing affordance probabilities and the uncertainty values, the control system can obtain an upper confidence bound (UCB) for exploration, which can be used to efficiently learn to find new graspable configurations in the scene. In some aspects, at each time step (e.g., for each set of input sensor data 305 or each time an action is requested or desired), the control system can score the possible configurations (e.g., each combination of a location and a set of action parameters) and select the highest-valued configuration (e.g., the location and set of action parameters having the highest score) to test.

In some aspects, during exploration, the actions are sampled or selected according to Equation 2 below:

$$r ( s , a ) = p ( g \vert s , a , θ ) + u ( s , a ) \qquad ( 2 )$$

where r(s, a) is the generated score of a given state s (e.g., a given location) using a given set of action parameters a, and p(g|s, a, θ) is the predicted probability of success for the state and action, as generated by the selected portion of the model (e.g., the interim affordance map 330 generated using the decoder 325 that corresponds to parameters θ).

In this way, the control system may generate a respective score for each respective pixel (e.g., for each location depicted by a pixel) in each respective interim affordance map 330 (e.g., for each set of action parameters). In some aspects, the control system then evaluates the generated scores to select the peak or highest score (e.g., the location and set of action parameters having the highest generated value). In this way, during exploration, the control system selects the action based on determining that performing the selected action (e.g., the action at the selected location and using the selected parameters) that will maximize (or at least increase) the predicted success while also minimizing (or at least reducing) the uncertainty.

As discussed above, this action may then be performed, and the success of the action can be evaluated to update or refine one or more parameters of the model. In some aspects, as discussed below in more detail, the control system may update a subset of the parameters, rather than all parameters. For example, the control system may only update the parameters of the selected decoder 325, leaving the other decoders unchanged, based on the success of the action. Similarly, in some aspects, the control system may use masked updating (e.g., masked backpropagation) to update only a subset of those parameter, such as by updating only the parameters that correspond to the selected action location (e.g., the parameters used to predict the success probability for the selected pixel(s)), such that parameters corresponding to other locations (e.g., other pixels in the interim affordance map 330) are unchanged.

In some aspects, during evaluation or use (e.g., runtime inferencing), where maximum accuracy may be preferred, the control system may use the average affordance probability map(s) (e.g., the affordance maps 345), obtained by averaging the probability values of the components in the ensemble, to select the best configuration to perform the action (e.g., the location and set of action parameters with the highest predicted probability of success). In some aspects, the control system may optionally incorporate the uncertainty maps 350 into this selection process (e.g., to select the least ambiguous configurations that are most likely to result in success).

In some aspects, during this runtime to robustness phase, the actions are sampled or selected according to Equation 3 below:

$$r ( s , a ) = {𝔼}_{θ ∼ Θ} [ p ( g \vert s , a , θ ) ] - u ( s , a ) \qquad ( 3 )$$

where r(s, a) is the generated score of a given state s (e.g., a given location) using a given set of action parameters a, p(g|s, a, θ) is the predicted probability of success for the state and action, as generated by a specific portion of the model (e.g., the interim affordance map 330 generated using a single decoder 325 that corresponds to parameters θ), and [symbol] _{θ˜Θ} reflects that the expected value (e.g., the average value across the interim affordance maps 330) is evaluated.

In this way, the control system may generate a respective score for each respective pixel or location in each respective affordance map 345 (e.g., for each set of action parameters). In some aspects, the control system then evaluates the generated scores to select the peak or highest score (e.g., the location and set of action parameters having the highest generated value). In this way, during inference, the control system selects the action based on determining that performing the selected action (e.g., the action at the selected location and using the selected parameters) will maximize, or at least increase, the predicted success while also minimizing, or at least reducing, the uncertainty.

In some aspects, in a similar manner to training, the selected action may then be performed, and the success of the action can be optionally evaluated to update or refine one or more parameters of the model.

### Example Operations for Executing Tasks in Affordance-Based Control Systems

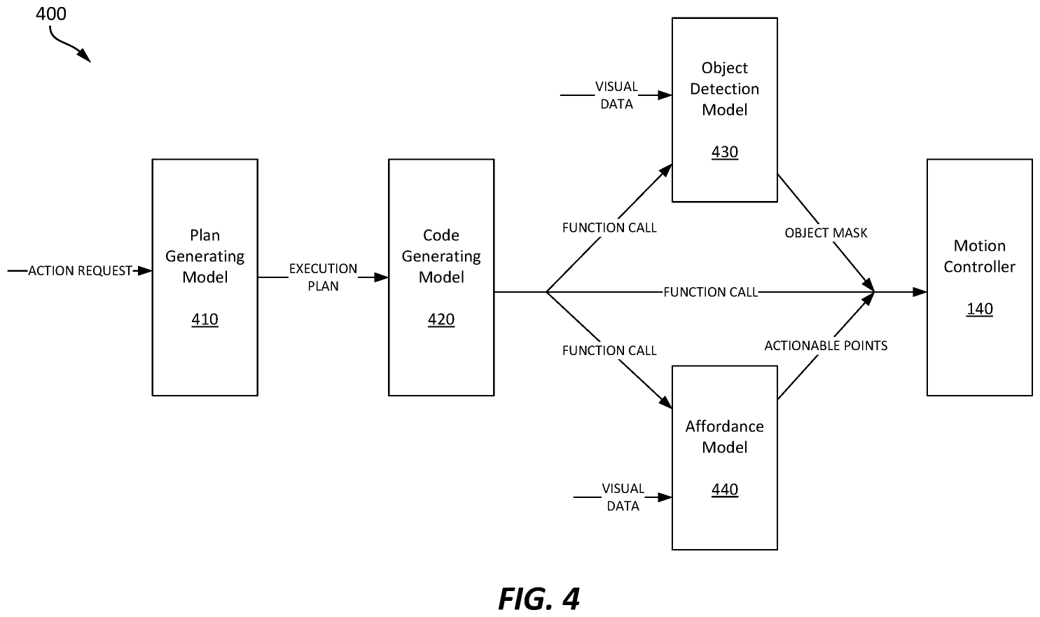

FIG. 4 illustrates an example pipeline 400 for performing a task within a physical environment based on a set of affordable actions, according to aspects of the present disclosure.

As illustrated in the pipeline 400, to perform a task within a physical environment, an action request specifying the task to be performed may be input into a plan generating model 410. In some aspects, the plan generating model 410 may be one of the control models 130 described above with respect to FIG. 1. Generally, the plan generating model 410 may be a generative artificial intelligence model that ingests an action request specifying an action to be performed within a physical environment and outputs an execution plan identifying a plurality of actions to perform in order to complete the action request.

The plan generating model 410 may, in some aspects, be trained to generate a natural language response identifying a plurality of actions to perform in order to complete the action request. In some aspects, sometimes referred to as “in-context” learning, a training data corpus including a plurality of action requests may be used to train the plan generating model 410. Each action request in the training data corpus may be mapped to a natural language response identifying a set of actions to be performed in order to complete that action request. The training data corpus may further include a set of predicates identifying various actions that can be performed within the physical environment. For example, in an environment in which a robotic arm operates, these predicates may identify actions such as picking up an item, placing an item (on an object, in an object, near an object, etc.), opening and closing locations in which objects can be stored, interacting with switches, or the like. The natural language response may include a description of an action to be performed and an object on which the action is to be performed, and, in some aspects, may further include a description of why such an action is to be performed in order to complete the action request. For example, the natural language response may be a set of {reasoning, action} pairs, with each pair corresponding to one of a plurality of actions to perform in order to complete the action request. In some aspects, learning may be based on setting model weights a priori for specific actions prior to deploying the model.

For example, assume that the plan generating model 410 ingests an action request that specifies that a robotic arm (or other autonomous system) retrieve an apple and place the apple on a table. The plan generating model 410, having been trained to generate an execution plan identifying a set of actions to be performed and the reasoning for performing each action in the set of actions, may respond with a set of actions including a first action specifying that the robotic arm is to pick up the apple and a second action specifying that the robotic arm is to place the apple on the table. The execution plan generated by the plan generating model 410 may then be output to a code generating model 420 for processing.

The code generating model 420 generally allows for the generation and execution of code to cause the robotic arm (or other autonomous system) to perform a specified action as a component of the larger task of completing the action request received at the plan generating model 410. Generally, the code generating model 420 may be a generative artificial intelligence model trained to generate one or more pieces of code that, when executed, causes the robotic arm to perform a task based on an action in the execution plan generated by the plan generating model 410. Generally, the generated code may include a plurality of function calls that (1) instruct the object detection model 430 to identify the object(s) on which the robotic arm (or other autonomous system) is to perform an action, (2) instruct the affordance model 440 to identify actionable points within the environment in which the robotic arm (or other autonomous system) operates, (3) combine an instruction to execute an action identified in the execution plan with the object(s) identified by the object detection model 430 and the actionable points identified by the affordance model 440, and (4) output an instruction to a motion controller (e.g., the motion controller 140 illustrated in FIG. 1) to perform the action based on the outputs of the objection detection model 430 and the affordance model 440. The affordance model 440 may correspond, for example, to one or more of the affordance models 120 illustrated in FIG. 1.

After the code generating model 420 generates the appropriate code, the code generating model 420 may cause the generated code to be executed. When an action has been successfully executed, the code generating model 420 can determine whether additional actions are to be performed in order to satisfy the action request. If there are additional actions to be performed, the code generating model 420 can generate subsequent code to prompt the object detection model 430 and affordance model 440 to generate object masks and actionable points for the next action to be performed in the set of actions identified by the execution plan, respectively, and to execute the next action in the action plan based on the generated object masks and actionable points for the next action.

The object detection model 430 ingests the execution plan and visual data (and/or other sensor data) from the environment in which the robotic arm (or other autonomous system) operates in order to identify the object(s) on which the robotic arm is to perform an action. In some aspects, the object detection model 430 may include various semantic segmentation models that classify objects in a visual representation of an operating environment into one of a plurality of groups (e.g., specific types of objects). The object detection model 430 may, for example, output an object mask identifying a location of an object (or objects) on which an action is to be performed. This object mask may be output to the motion controller 140 and combined with actionable points generated by the affordance model 440 to cause the robotic arm to perform a specific action, as discussed in further detail below.

The affordance model 440 generally identifies actionable points within the environment in which the robotic arm (or other autonomous system) operates. Generally, these actionable points may identify features corresponding to affordable actions that can be performed within the environment in which the robotic arm operates. In some aspects, these features may be associated with a variety of objects and identify objects against which a particular action can be performed and objects against which that particular action cannot be performed. For example, these actionable points may differentiate between movable objects and stationary objects. Further, these actionable points may differ based on the action to be performed by the robotic arm (or other autonomous system) within the environment. For example, switches or dials may be grasped and manipulated (e.g., moved laterally or axially); however, switches or dials may not be picked up because such switches or dials are attached to some other device which may be stationary or at least sufficiently heavy that the robotic arm (or other autonomous system) is unable to pick up that other device. Thus, if an action specifies that an object is to be picked up, the affordance model 440 may not identify points associated with these switches or dials as points with which the robotic arm can interact in order to perform the action of picking up an item. Meanwhile, objects that are not attached to any other object (e.g., objects sitting on a table, shelf, or other surface) may be objects with which the robotic arm can interact in order to perform the action of picking up an item. Thus, the affordance model 440 can identify points associated with these objects as points which can be acted upon by the robotic arm in order to perform the action of picking up an item.

Generally, because the environment in which the robotic arm operates may change as actions are performed, the object detection model 430 and the affordance model 440 may be configured to generate object masks and actionable points, respectively, in sequence based on the successful execution of a predicate action. That is, for an action request which can be satisfied by the execution of multiple steps, the object detection model 430 and the affordance model 440 may generate object masks and actionable points for the n+1^{th} action in the execution plan after successful completion of the n^{th} action in the execution plan.

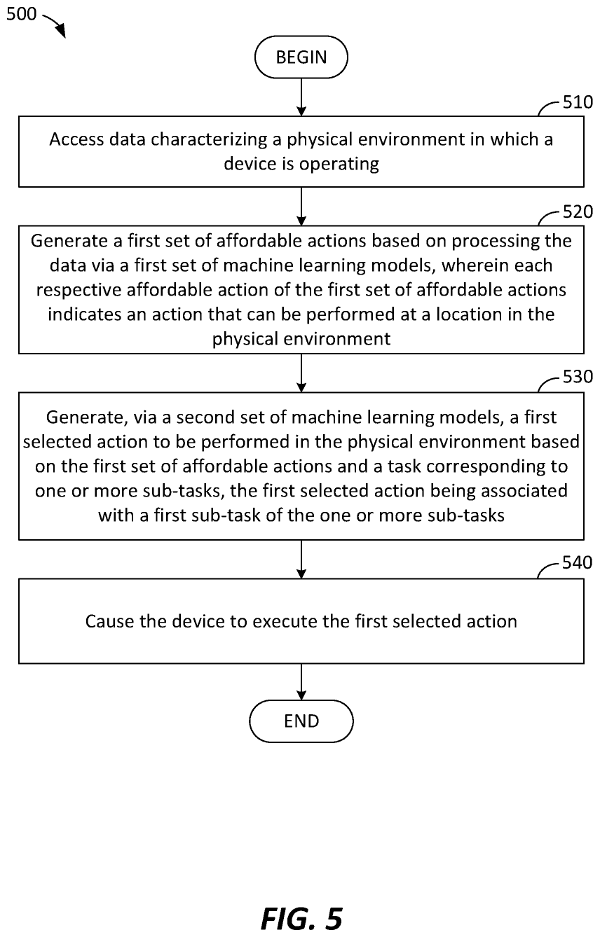

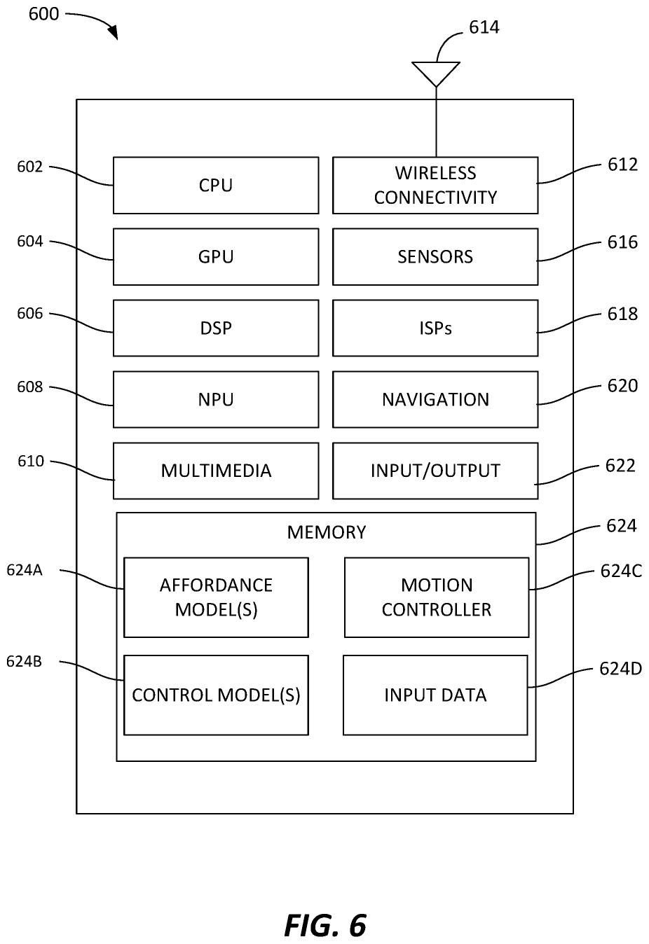

FIG. 5 illustrates example operations 500 for processing data using a set of machine learning models to cause a device to perform a task, according to aspects of the present disclosure. The operations 500 may be performed, for example, by a computing system (e.g., the affordance-based control system 100) on which a set of machine learning models is deployed for processing input data, such as a device controller, a robot control unit, an appliance, an autonomous vehicle, a smartphone, a tablet computer, or other computing system (e.g., such as processing system 600 illustrated in FIG. 6 and described in further detail below).

As illustrated, the operations 500 begin at block 510, with accessing data characterizing a physical environment in which a device is operating. The data may include, for example, image data, sensor data (e.g., distances between the device and objects, distances relative to an established datum point, etc.), or other data that provides information about the physical environment in which the device is operating and spatial relationships between different objects in the physical environment.

At block 520, the operations 500 proceed with generating a first set of affordable actions. In various aspects, the first set of affordable actions may be generated by processing data characterizing a physical environment in which the device is operating via a first set of machine learning models (e.g., the affordance models 120). Each affordable action included in the first set of affordable actions may indicate an action that can be performed at a location in the physical environment using a respective set of action parameters.

At block 530, the operations 500 proceed with generating, via a second set of machine learning models, a first selected action to be performed by the device based on the set of affordable actions and a task corresponding to one or more sub-tasks. The first selected action may be associated with a first sub-task of the one or more tasks.

In some aspects, the first action is generated by selecting a particular affordable action included in the set of affordable actions via a second set of machine learning models (e.g., the control models 130). The selected affordable action may correspond to a next sub-task to be performed by the device. The second set of machine learning models may further modify a set of action parameters associated with the selected affordable action to generate a set of modified action parameters.

In some aspects, the one or more sub-tasks include a sequence of sub-tasks. The operations 500 may further include decomposing, via the second set of machine learning models, the task into the sequence of sub-tasks.

In some aspects, each respective affordable action of the set of affordable actions indicates a respective probability that the affordable action can be performed at a given location in the physical environment. The selected affordable action may be the affordable action having the highest probability in the set of affordable actions.

In some aspects, generating the set of affordable actions may include generating a set of output affordance maps. Each output affordance map may correspond to a respective affordable action in the set of affordable actions. In some aspects, the operations 500 may further include decomposing the set of output affordance maps into a plurality of patches, generating a plurality of embeddings based on the plurality of the patches, and outputting the plurality of embeddings to the second set of machine learning models.

In some aspects, generating the set of affordable actions includes generating a set of word tokens. Each word token of the set of word tokens generally may correspond to a textual description of a respective affordable action of the set of affordable actions.

At block 540, the operations 500 proceed with causing the device to execute the first selected action. For example, action parameters may be output to a motion controller that converts the action parameters into control signals for executing the next action via the device.

In some aspects, each affordable action of the first set of affordable actions corresponds to a respective set of action parameters. To generate the first selected action, the second set of machine learning models may select a first affordable action included in the first set of affordable actions and modify the set of action parameters associated with the first affordable action to generate a set of modified action parameters. The first selected action may be executed based on the set of modified action parameters. In some aspects, causing the device to execute the first selected action includes converting the set of modified action parameters into one or more control signals for output to the device in the physical environment. In some aspects, the set of word tokens may be based on a set of features extracted from a set of affordance maps generated by the first set of machine learning models.

In some aspects, the second set of machine learning models may be large language models (LLMs). The selected action may be an action associated with a next token (e.g., a next word or part of a word) generated by the LLM.

In some aspects, each affordable action of the set of affordable actions may correspond to a respective set of action parameters. Each set of action parameters may correspond to at least one of a location of an object in the physical environment, an orientation in which to interact with the object in the physical environment, or a force to be applied to the object in the physical environment. The orientation may include, for example, a grasp orientation for a robotic grasper.

In some aspects, the first set of machine learning models may include a set of convolutional neural networks. Each convolutional neural network included in the set of convolutional neural networks may correspond to a different type of action that can be performed by the device.

In some aspects, the second set of machine learning models may include a set of transformer neural networks.

In some aspects, the operations 500 further include monitoring the execution of the next action by the device. Execution of the next action may be monitored based on processing additional data characterizing the physical environment, such as image data and/or data indicating the current state of the device. Execution of the next action may, in some aspects, be modified. For example, based on determining that the next action should be modified, the action parameters corresponding to the next action are adjusted to generate adjusted action parameters. Additionally or alternatively, based on determining that the next action should be modified, a stop signal may be transmitted to the device and/or motion controller to cause the device to stop performing the next action. In some aspects, the operations 500 may further include determining whether an additional sub-task included in the sequence of sub-tasks is to be performed to accomplish the task. If an additional sub-task is to be performed, then the operations 500 may be repeated.

In some aspects, the operations 500 include determining that the device has executed the first selected action. Second data characterizing the physical environment after execution of the first selected action may be accessed, and a second set of affordable actions may be generated based on processing the second data via the first set of machine learning models. Generally, each respective affordable action of the second set of affordable actions indicates an action that can be performed conditioned on the device having executed the first selected action. A second selected action to be performed with the object in the physical environment may be generated based on the task and the second set of affordable actions, and the device may be caused to execute the second selected action. In some aspects, the second set of affordable actions includes at least one action that is not included in the first set of affordable actions, and the first set of affordable actions includes at least one action that is not included in the second set of affordable actions. In some aspects, the device comprises a robot, causing the device to execute the first selected action comprises causing the robot to grasp an object located in the physical environment, and the second selected action comprises an action performed by the robot with the object. In some aspects, the operations 500 may further include generating, via the second set of machine learning models, a third selected action to be performed based on the task and a third set of affordable actions, wherein each respective affordable action of the third set of affordable actions indicates an action that can be performed conditioned on the device having executed the second selected action; and causing the device to execute the third selected action.

### Example Processing System for Processing Data Using a Set of Machine Learning Models to Cause a Device to Perform a Task

FIG. 6 depicts an example processing system 600 configured to perform various aspects of the present disclosure, including, for example, the techniques and methods described with respect to FIGS. 1-5. In some aspects, the processing system 600 may train, implement, or provide a set of machine learning models, such as the affordance models and control models included in the affordance-based control system 100 of FIG. 1. Although depicted as a single system for conceptual clarity, in at least some aspects, as discussed above, the operations described below with respect to the processing system 600 may be distributed across any number of devices.

The processing system 600 includes a central processing unit (CPU) 602, which in some examples may be a multi-core CPU. Instructions executed at the CPU 602 may be loaded, for example, from a program memory associated with the CPU 602 or may be loaded from a partition of memory 624.

The processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation connectivity (e.g., 5G or New Radio (NR)), Wi-Fi connectivity, Bluetooth connectivity, and other wireless transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes affordance models 624A, control models 624B, a motion controller 624C (which may additionally or alternatively be implemented as one or more fixed function hardware circuits), and input data 624D. Though depicted as discrete components for conceptual clarity in FIG. 6, the illustrated components (and others not depicted) may be collectively or individually implemented in various aspects.

Generally, the processing system 600 and/or components thereof may be configured to perform the methods described herein.

Notably, in other aspects, aspects of the processing system 600 may be omitted, such as where the processing system 600 is a server computer or the like. For example, the multimedia processing unit 610, the wireless connectivity component 612, the sensor processing units 616, the ISPs 618, and/or the navigation component 620 may be omitted in other aspects. Further, aspects of the processing system 600 may be distributed between multiple devices.

### Example Clauses

Implementation details of various aspects of the present disclosure are described in the following numbered clauses:

Clause 1: A processor-implemented method, comprising: accessing data characterizing a physical environment in which a device is operating; generating a first set of affordable actions based on processing the data via a first set of machine learning models, wherein each respective affordable action of the first set of affordable actions indicates an action that can be performed at a location in the physical environment; generating, via a second set of machine learning models, a first selected action to be performed in the physical environment based on the first set of affordable actions and a task corresponding to one or more sub-tasks, the first selected action being associated with a first sub-task of the one or more sub-tasks; and causing the device to execute the first selected action.

Clause 2: The method of Clause 1, wherein the one or more sub-tasks comprises a sequence of sub-tasks, and further comprising decomposing, via the second set of machine learning models, the task into the sequence of sub-tasks.

Clause 3: The method of Clause 1 or 2, wherein: each affordable action of the first set of affordable actions corresponds to a respective set of action parameters; generating, via the second set of machine learning models, the first selected action comprises: selecting a first affordable action included in the first set of affordable actions; and modifying the set of action parameters associated with the first affordable action to generate a set of modified action parameters; and the device executes the first selected action based on the set of modified action parameters.

Clause 4: The method of Clause 3, wherein causing the device to execute the first selected action comprises converting the set of modified action parameters into one or more control signals for output to the device in the physical environment.

Clause 5: The method of any of Clauses 1-4, further comprising: determining that the device has executed the first selected action; accessing second data characterizing the physical environment after execution of the first selected action; generating a second set of affordable actions based on processing the second data via the first set of machine learning models, and each respective affordable action of the second set of affordable actions indicates an action that can be performed conditioned on the device having executed the first selected action; generating, via the second set of machine learning models, a second selected action to be performed with the object in the physical environment based on the task and the second set of affordable actions; and causing the device to execute the second selected action.

Clause 6: The method of Clause 5, wherein the second set of affordable actions includes at least one action that is not included in the first set of affordable actions, and wherein the first set of affordable actions includes at least one action that is not included in the second set of affordable actions.

Clause 7: The method of Clause 5 or 6, wherein: the device comprises a robot, causing the device to execute the first selected action comprises causing the robot to grasp an object located in the physical environment, and the second selected action comprises an action performed by the robot with the object.

Clause 8: The method of Clause 7, further comprising: generating, via the second set of machine learning models, a third selected action to be performed based on the task and a third set of affordable actions, wherein each respective affordable action of the third set of affordable actions indicates an action that can be performed conditioned on the device having executed the second selected action; and causing the device to execute the third selected action.

Clause 9: The method of any of Clauses 1-8, further comprising, while the device is executing the first selected action: monitoring, via the second set of machine learning models, a state of the device; and in response to determining, via the second set of machine learning models, that the first selected action should be modified: adjusting, via the second set of machine learning models, one or more action parameters corresponding to the first selected action, or causing the device to stop performing the first selected action.

Clause 10: The method of any of Clauses 1-9, wherein each respective affordable action of the first set of affordable actions further indicates a respective probability that the affordable action can be performed at the location in the physical environment, and wherein the first selected action comprises an affordable action having a highest probability of the first set of affordable actions.

Clause 11: The method of any of Clauses 1-10, wherein generating the first set of affordable actions comprises generating a set of output affordance maps, wherein each output affordance map of the set of output affordance maps corresponds to a respective affordable action of the first set of affordable actions.

Clause 12: The method of Clause 11, further comprising: decomposing the set of output affordance maps into a plurality of patches; generating a plurality of embeddings based on the plurality of the patches; and outputting the plurality of embeddings to the second set of machine learning models.

Clause 13: The method of any of Clauses 1-12, wherein generating the first set of affordable actions comprises generating a set of word tokens, wherein each word token of the set of word tokens corresponds to a textual description of a respective affordable action of the first set of affordable actions.

Clause 14: The method of Clause 13, wherein the set of word tokens is based on a set of features extracted from a set of output affordance maps generated by the first set of machine learning models.

Clause 15: The method of Clause 13 or 14, wherein the second set of machine learning models comprises a large language model (LLM).

Clause 16: The method of Clause 15, wherein the first selected action comprises an action associated with a next word token generated by the LLM.

Clause 17: The method of any of Clauses 1-16, wherein each affordable action of the first set of affordable actions corresponds to a respective set of action parameters, and wherein each set of action parameters corresponds to at least one of a location of an object in the physical environment, an orientation in which to interact with the object in the physical environment, or a force to be applied to the object in the physical environment.

Clause 18: The method of Clause 17, wherein the orientation comprises a grasp orientation for a robotic grasper.

Clause 19: The method of any of Clauses 1-18, wherein the first set of machine learning models comprises a set of convolutional neural networks, and wherein each convolutional neural network included in the set of convolutional neural networks corresponds to a different type of action that can be performed by the device.

Clause 20: The method of any of Clauses 1-19, wherein the second set of machine learning models comprises a set of transformer neural networks.

Clause 21: The method of any of Clauses 1-20, wherein generating the first set of affordable actions comprises: generating, via a first generative artificial intelligence model, an execution plan including a plurality of sub-actions to complete a task in the physical environment, each respective sub-action identifying a respective operation to perform on a respective object in the physical environment; and for each respective sub-action in the execution plan, generating a respective affordable action based on an object map identifying a location of the respective object in the physical environment and an identified actionable point associated with the respective object.

Clause 22: The method of Clause 21, wherein generating the first selected action to be performed in the physical environment comprises generating, via a second generative artificial intelligence model, executable code for performing the first selected action based on a first sub-action in the execution plan.

Clause 23: A system, comprising: a memory having executable instructions stored thereon; and a processor configured to execute the executable instructions in order to cause the system to perform the method of any of Clauses 1 through 22.

Clause 24: A system comprising means for performing the method of any of Clauses 1 through 22.

Clause 25: A computer-readable medium having executable instructions stored thereon which, when executed by a processor, cause the processor to perform the method of any of Clauses 1 through 22.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for controlling a device using machine learning models, comprising:
at least one memory having executable instructions stored thereon; and
one or more processors configured to execute the executable instructions to cause the processing system to:
access data characterizing a physical environment in which the device is operating;
generate a first set of affordable actions based on processing the data via a first set of machine learning models, wherein each respective affordable action of the first set of affordable actions indicates an action that can be performed at a location in the physical environment;
generate, via a second set of machine learning models, a first selected action to be performed in the physical environment based on the first set of affordable actions and a task corresponding to one or more sub-tasks, the first selected action being associated with a first sub-task of the one or more sub-tasks; and
cause the device to execute the first selected action.

2. The processing system of claim 1, wherein the one or more sub-tasks comprises a sequence of sub-tasks, and the one or more processors are further configured to cause the processing system to decompose, via the second set of machine learning models, the task into the sequence of sub-tasks.

3. The processing system of claim 1, wherein:
each affordable action of the first set of affordable actions corresponds to a respective set of action parameters;
to generate, via the second set of machine learning models, the first selected action, the one or more processors are configured to cause the processing system to:
select a first affordable action included in the first set of affordable actions; and
modify the set of action parameters associated with the first affordable action to generate a set of modified action parameters; and
the device executes the first selected action based on the set of modified action parameters.

4. The processing system of claim 3, wherein to cause the device to execute the first selected action, the one or more processors are configured to cause the processing system to convert the set of modified action parameters into one or more control signals for output to the device in the physical environment.

5. The processing system of claim 1, wherein the one or more processors are further configured to cause the processing system to:
determine that the device has executed the first selected action;
access second data characterizing the physical environment after execution of the first selected action;
generate a second set of affordable actions based on processing the second data via the first set of machine learning models, and each respective affordable action of the second set of affordable actions indicates an action that can be performed conditioned on the device having executed the first selected action;
generate, via the second set of machine learning models, a second selected action to be performed with an object in the physical environment based on the task and the second set of affordable actions; and
cause the device to execute the second selected action.

6. The processing system of claim 5, wherein the second set of affordable actions includes at least one action that is not included in the first set of affordable actions, and wherein the first set of affordable actions includes at least one action that is not included in the second set of affordable actions.

7. The processing system of claim 5, wherein:
the device comprises a robot,
to cause the device to execute the first selected action, the one or more processors are configured to cause the processing system to cause the robot to grasp the object located in the physical environment, and
the second selected action comprises an action performed by the robot with the object.

8. The processing system of claim 7, wherein the one or more processors are further configured to cause the processing system to:
generate, via the second set of machine learning models, a third selected action to be performed based on the task and a third set of affordable actions, wherein each respective affordable action of the third set of affordable actions indicates an action that can be performed conditioned on the device having executed the second selected action; and
cause the device to execute the third selected action.

9. The processing system of claim 1, wherein the one or more processors are configured to cause the processing system to, while the device is executing the first selected action:
monitor, via the second set of machine learning models, a state of the device; and
in response to a determination, via the second set of machine learning models, that the first selected action should be modified:
adjust, via the second set of machine learning models, one or more action parameters corresponding to the first selected action, or
cause the device to stop performing the first selected action.

10. The processing system of claim 1, wherein each respective affordable action of the first set of affordable actions further indicates a respective probability that the affordable action can be performed at the location in the physical environment, and wherein the first selected action comprises an affordable action having a highest probability of the first set of affordable actions.

11. The processing system of claim 1, wherein to generate the first set of affordable actions, the one or more processors are configured to cause the processing system to generate a set of output affordance maps, wherein each output affordance map of the set of output affordance maps corresponds to a respective affordable action of the first set of affordable actions.

12. The processing system of claim 11, wherein the one or more processors are further configured to cause the processing system to:
decompose the set of output affordance maps into a plurality of patches;
generate a plurality of embeddings based on the plurality of the patches; and
output the plurality of embeddings to the second set of machine learning models.

13. The processing system of claim 1, wherein to generate the first set of affordable actions, the one or more processors are configured to cause the processing system to generate a set of word tokens, wherein each word token of the set of word tokens corresponds to a textual description of a respective affordable action of the first set of affordable actions.

14. The processing system of claim 13, wherein the set of word tokens is based on a set of features extracted from a set of output affordance maps generated by the first set of machine learning models.

15. The processing system of claim 1, wherein each affordable action of the first set of affordable actions corresponds to a respective set of action parameters, and wherein each set of action parameters corresponds to at least one of a location of an object in the physical environment, an orientation in which to interact with the object in the physical environment, or a force to be applied to the object in the physical environment.

16. The processing system of claim 1, wherein the first set of machine learning models comprises a set of convolutional neural networks, and wherein each convolutional neural network included in the set of convolutional neural networks corresponds to a different type of action that can be performed by the device.

17. The processing system of claim 1, wherein to generate the first set of affordable actions, the one or more processors are configured to cause the processing system to:
generate, via a first generative artificial intelligence model, an execution plan including a plurality of sub-actions to complete a task in the physical environment, each respective sub-action identifying a respective operation to perform on a respective object in the physical environment; and
for each respective sub-action in the execution plan, generate a respective affordable action based on an object map identifying a location of the respective object in the physical environment and an identified actionable point associated with the respective object.

18. The processing system of claim 17, wherein to generate the first selected action to be performed in the physical environment, the one or more processors are configured to cause the processing system to generate, via a second generative artificial intelligence model, executable code for performing the first selected action based on a first sub-action in the execution plan.

19. A processor-implemented method for controlling a device using machine learning models, comprising:
accessing data characterizing a physical environment in which a device is operating;
generating a first set of affordable actions based on processing the data via a first set of machine learning models, wherein each respective affordable action of the first set of affordable actions indicates an action that can be performed at a location in the physical environment;
generating, via a second set of machine learning models, a first selected action to be performed in the physical environment based on the first set of affordable actions and a task corresponding to one or more sub-tasks, the first selected action being associated with a first sub-task of the one or more sub-tasks; and
causing the device to execute the first selected action.

20. The method of claim 19, wherein generating the first set of affordable actions comprises:
generating, via a first generative artificial intelligence model, an execution plan including a plurality of sub-actions to complete a task in the physical environment, each respective sub-action identifying a respective operation to perform on a respective object in the physical environment; and
for each respective sub-action in the execution plan, generating a respective affordable action based on an object map identifying a location of the respective object in the physical environment and an identified actionable point associated with the respective object.
